(19) United States
(12) Patent Application Publication
(10) Pub. No.: US 2025/0253525 A1
(43) Pub. Date: Aug. 7, 2025

(54) Improved multi-port elementary antenna and associated active electronically scanned array antenna

(71) Applicants: THALES, Meudon (FR); UNIVERSITÉ DE BORDEAUX, BORDEAUX (FR); Centre national de la recherche scientifique, PARIS (FR); INSTITUT POLYTECHNIQUE DE BORDEAUX, TALENCE CEDEX (FR)

(72) Inventors: Anthony GHIOTTO, TALENCE (FR); Timothée LE GALL, TRAPPES (FR); Stefan VARAULT, TRAPPES (FR); Bruno LOUIS, ELANCOURT (FR)

(21) Appl. No.: 19/043,511

(22) Filed: Feb. 2, 2025

(30) Foreign Application Priority Data
Feb. 6, 2024 (FR) 2401135

(51) Int. Cl. H01Q 3/30; H01Q 9/04; H01Q 21/06

(52) U.S. Cl. CPC H01Q 3/30; H01Q 9/045; H01Q 21/065

(57) ABSTRACT

The elementary antenna includes a radiating element, provided with N excitation zones, and a transmit and receive module, including, for each integer i between 1 and N, an i-th chain connected, via an i-th feed line to the i-th excitation zone, the i-th chain including an i-th amplifier. The elementary antenna includes, in the i-th chain, an i-th robustness phase shifter on a first side of the i-th amplifier, between the i-th amplifier and the radiating element, and an i-th compensation phase shifter on a second side of the i-th amplifier, opposite the first side. The sum of phases brought in by the i-th robustness phase shifter and compensation phase shifter is constant whatever the chain considered, and the phase brought in by the i-th robustness phase shifter is strictly different from the phase brought in by the other robustness phase shifters of the other chains of the elementary antenna.

### REFERENCE TO RELATED APPLICATION

This application is a U.S. non-provisional application claiming the benefit of French Patent Application No. 24 01135 filed on Feb. 6, 2024, the contents of which are incorporated herein by reference in their entirety.

### TECHNICAL FIELD OF THE INVENTION

The invention relates to active electronically scanned array antennas. Such an array antenna associates a plurality of elementary antennas, each elementary antenna comprising a Transmit and Receive Module (TRM) and a radiating element.

### BACKGROUND OF THE INVENTION

Document FR 3062523 discloses an array antenna, each radiating element of which is characterized by at least two excitation ports, each port being connecter to one TRM by a transmission line. Preferably, each radiating element is connected to the TRM by four ports (or eight ports in a differential arrangement).

The different ports form, in transmission, as many power injection points so as to increase the total power of the wave emitted by the radiating element.

The different ports form, in reception, as many power collection points so as to distribute the total power of the incident wave on the radiating element.

These are array antennas primarily designed for high-power applications, such as radar applications.

Each port is connected to a dedicated transmitting and/or receiving chain of the TRM, if appropriate via a duplexer, such as e.g. a circulator or a switch.

The transmitter chain conventionally includes a controllable phase shifter followed by a power amplifier in order to apply to the corresponding port a transmit signal adjusted in phase and amplitude.

In designing the antenna, the features of the power amplifier and same of the radiating element are jointly optimized. More particularly, the impedance of the load which is connected to the output of the power amplifier, via a transmit line, is optimized according to the features desired for the power amplifier, such as the efficiency, the output power, the linearity thereof, etc. An optimal impedance is thereby defined making possible a matching of the load connected to the output of the power amplifier so as to transmit the power delivered by the power amplifier to the radiating element with high efficiency.

However, once the elementary antenna is integrated into an array antenna, electromagnetic coupling between active radiating elements of the different elementary antennas are at the origin of an impedance mismatch. In other words, the radiating element connected to the output of the power amplifier of an elementary antenna no longer has the initial optimum impedance Zₒₚₜ, but a modified impedance Z₀. Thereof is the active load pulling effect. This load pulling can also come from a mismatch of the radiating element due to a modification of the close environment thereof, or from an external disturbing signal received by the antenna (e.g., for use in electronic warfare).

The consequence of such impedance mismatch is a degradation of the efficiency of the power amplifier. Such loss of efficiency typically results in an attenuation of the emitted wave on the order of one decibel.

The same problem is found on the receiver chain associated with a port of the radiating element. The receiver chain includes a low-noise amplifier to the input of which is applied the received signal, collected by the corresponding port. However, during the design of the elementary antenna, the low-noise amplifier is dimensioned according to the impedance of the load connected to the input thereof. An optimum impedance Zₒₚₜ is thereby determined. However, in real-life use, impedance mismatch can occur, for example, as a result of electromagnetic couplings between adjacent radiating elements lead to an impedance mismatch. The impedance Z₀ of the load connected to the input of the low-noise amplifier is different from the optimum impedance Zₒₚₜ. Such impedance mismatch at reception results in a loss of efficiency in the transmission of the power from the radiating device to the low-noise amplifier, and a degradation of the noise factor.

Also known in the field of array antennas for base stations of a radiocommunication infrastructure is document WO 2023/072749.

This document relates to an array antenna comprising a plurality of sub-arrays, each consisting of a pair of radiating elements. The sub-arrays are arranged in a matrix of rows and columns.

Each sub-array of radiating elements is connected to a power amplifier of a transmission/reception chain via a transmission line.

However, in beam-forming operating mode, electromagnetic coupling between the antenna's active sub-arrays results in a phenomenon of active impedance load which degrades the electric adaptation between the power amplifier and the sub-array (including the transmission line).

To neutralize this mismatch across the entire array antenna, WO 2023/072749 proposes to differentially modify the length of the transmission lines between power amplifiers and sub-arrays so as to introduce a delay. More precisely, the sub-arrays of the same columns are characterized by the same delay, while the delays between the sub-arrays of two different rows is a multiple of λ/8.

A compensation phase shift is introduced, upstream of each power amplifier, by the beam-forming phase adaptation means to neutralize the delay introduced downstream of the power amplifier.

In this way, the different waves emitted by the sub-arrays belonging to different rows of the array antenna recombine in the air so as to attenuate the effects of active impedance load when used in the beamforming mode.

However, document WO 2023/072749 provides for the same correction for different sub-arrays on the same row, whereas the active load impedance phenomenon depends on the environment of each sub-array, i.e., its position in the array antenna.

In fact, the technical solution proposed in document WO 2023/072749 involves several sub-arrays (and therefore several radiating elements) with different physical positions and consequently different active adaptation coefficients.

The technical solution proposed in WO 2023/072749 is therefore insufficient to minimize the dispersion of the reflection coefficient (or standing wave ratio—SWR) across the entire array antenna.

This is all the more so as reflection coefficient dispersion can have causes other than coupling between neighboring radiating elements in beam-forming mode. Other phenomena, such as external electromagnetic aggression, can degrade the electric adaptation between the power amplifier and its load.

### SUMMARY OF THE INVENTION

The aim of the invention is therefore to propose an improved antenna that guarantees greater robustness of the reflection coefficient over the whole antenna, regardless of the type of use (i.e., the cause of a possible adaptation loss of the load connected to the amplifier).

To this end, the subject matter of the invention is an elementary antenna comprising a radiating element and a transmit and/or receive module, the radiating device including N excitation zones, N being an integer greater than or equal to 2, an excitation zone being a port or a pair of ports, the transmit and/or receive module including, for each integer i between 1 and N, an i-th chain connected, via an i-th feed line to the i-th excitation zone of the radiating element, the i-th chain including an i-th amplifier, characterized in that the elementary antenna includes, for each chain, an i-th robustness phase shifter of a first side of the i-th amplifier, between the i-th amplifier and the radiating element, and an i-th compensation phase shifter of a second side of the i-th amplifier opposite the first side, and in that the sum of the phases brought in by the i-th robustness phase shifter and the i-th compensation phase shifter is constant whichever the chain considered, and the phase brought in the i-th robustness phase shifter is strictly different from the phase brought in by the other robustness phase shifters of the other chains of the elementary antenna.

According to particular embodiments, the horn antenna includes one or more of the following features, taken individually or according to all technically possible combinations:
each chain a transmitter chain, the amplifier of the i-th chain being a power amplifier.
each chain is a receiver chain the amplifier of the i-th chain being a low-noise amplifier.
the phases brought in by the robustness phase shifters are uniformly distributed over the interval [0°; 180°[.
since the radiating element includes four ports, the phases brought in by the first, second, third and fourth robustness phase shifters, respectively, are chosen equal to 0°, 45°, 90° and 135°.
the phases brought in by the first, second, third and fourth compensation phase shifters, respectively, are chosen to be equal to 135°, 90°, 45° and 0°.
since the radiating element includes N pairs of ports, the i-th chain includes an i-th positive amplifier and an i-th positive robustness phase shifter associated with a positive port of the i-th pair of ports, and an i-th negative amplifier and an i-th negative robustness phase shifter associated with a negative port of the i-th pair of ports.
the i-th robustness phase shifter consists of an i-th delay line.
the i-th compensation phase shifter is integrated into an i-th controllable phase shifter of the i-th chain.

A further subject matter of the invention is an active electronically scanned array antenna including a plurality of elementary antennas, characterized in that each elementary antenna is consistent with the preceding elementary antenna.

### BRIEF DESCRIPTION OF THE DRAWINGS

The invention and the advantages of the invention will be better understood upon reading the following detailed description of the different embodiments of the invention, given only as examples and not limited to, the description being made with reference to the enclosed drawings, wherein:

FIG. 1 is a schematic representation of a first embodiment of the multi-port elementary antenna according to the invention;

FIG. 2 is a graph representing a Smith chart;

FIG. 3 is a schematic representation of a second embodiment of a multi-port elementary antenna according to the invention, in a differential assembly; and

FIG. 4 is a schematic representation of a third embodiment of the multi-port elementary antenna according to the invention, in a differential assembly.

### DETAILED DESCRIPTION OF THE INVENTION

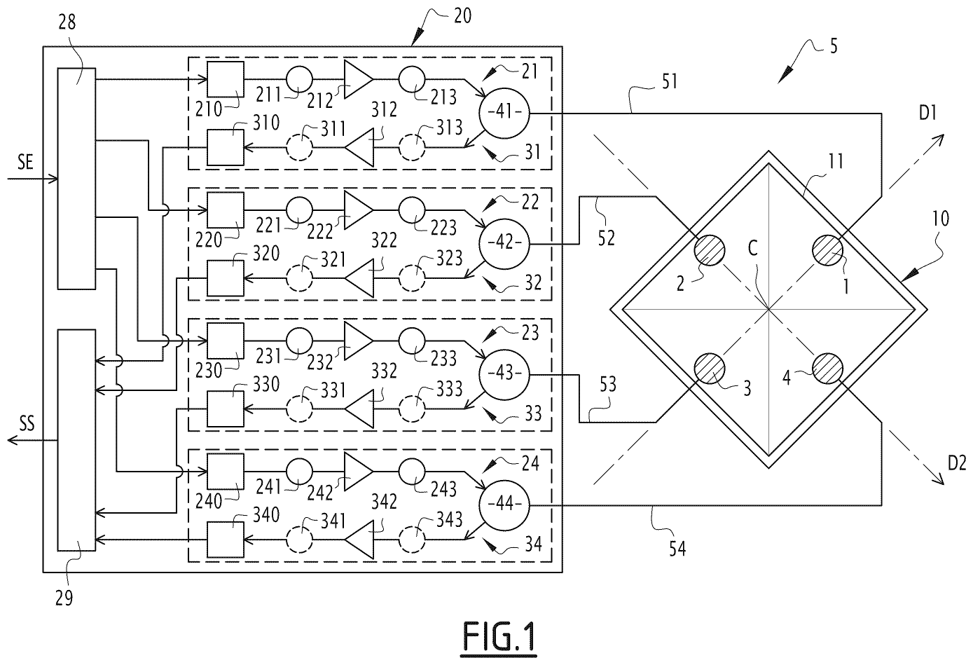

FIG. 1 represents a first embodiment of a multi-port elementary antenna according to the invention.

The elementary antenna 5 includes a radiating element 10 and a transmit and receive module, or TRM 20, associated with the radiating element.

The radiating element 10 includes a radiating plane, e.g. metallic and with a square shape. In a variant, the radiating plane may take other shapes, in particular a circular shape.

The radiating plane of the radiating element 10 is characterized by two mutually orthogonal directions, each direction passing through the middle of two opposite sides of the radiating element. The first and second directions, D1 and D2, intersect at the center C of the radiating plane.

In the first embodiment, the total number N of ports is chosen to be equal e.g. to four.

Along the first direction D1, the radiating element 10 is provided with a first port 1 and a third port 3, which are arranged on both sides of the center C of the radiating element.

Along the second direction D2, the radiating element 10 is provided with a second port 2 and a fourth port 4, which are arranged on both sides of the center C.

For example, a port is formed by the end of a feed line overlapping a slot provided in a ground plane below the radiating plane. For example again, a port consists of the end of a feed line connected, by a via extending through the ground plane, to the back of the radiating plane.

The TRM 20 has four channels, each addressing a particular port of the radiating element.

Each channel includes a transmitter chain and a receiver chain.

Thereby, the TR module 20 includes a first transmitter chain 21 and a first receiver chain 31 connected, via a first duplexer 41, to a first feed line 51, the end of which is connected or forms the first port 1.

Thereby, the TRM 20 includes a second transmitter chain 22 and a second receiver chain 32 connected, via a second duplexer 42, to a second feed line 52 of the second port 2.

Thereby, the TRM 20 includes a third transmitter chain 23 and a third receiver chain 33 connected, via a third duplexer 43, to a third feed line 53, the end of which is connected to the third port 3.

Thus, the TRM 20 includes a fourth transmitter chain 24 and a fourth receiver chain 34 connected, via a fourth duplexer 44, to a fourth feed line 54, the end of which is connected to the fourth port 4.

Furthermore, the TRM 20 includes an input component 28 making it possible to receive a transmission signal SE to be transmitted from an electronic transmission system (not shown in the figures), and to repeat the input signal on the input of each of the transmitter chains 21 to 24 of the TR module 20.

The TRM 20 includes an output component 29 making it possible to combine the signals received delivered to the output of each of the receiver chains 31 to 34 of the TRM 20, so as to transmit an output signal SS to a processing electronic system (not shown in the figures).

Conventionally, for the formation of a beam each transmitter chain includes, in series, a controllable phase shifter and a power amplifier. Such formation of a beam makes it possible to radiate the energy in one or a plurality of desired directions, and in a chosen polarization. Depending on the nature of the radiating element, the antenna can permit a polarization agility.

Thereby, the first transmitter chain 21 includes a controllable phase shifter 210 and a power amplifier 212, the second transmitter chain 22 includes a controllable phase shifter 220 and a power amplifier 222, the third transmitter chain 23 includes a controllable phase shifter 230 and a power amplifier 232, and the fourth transmitter chain 24 includes a controllable phase shifter 240 and a power amplifier 242.

According to the invention, each transmitter chain is further provided with a robustness phase shifter and with a compensation phase shifter.

Thereby, the first transmitter chain 21 includes a robustness phase shifter 213 and a compensation phase shifter 211, the second transmitter chain 22 includes a robustness phase shifter 223 and a compensation phase shifter 221, the third transmitter chain 23 includes a robustness phase shifter 233 and a compensation phase shifter 231, and the fourth transmitter chain 24 includes a robustness phase shifter 243 and a compensation phase shifter 241.

A transmitter chain can be identified by the integer i of the port to which the chain is connected.

In the embodiment shown in FIG. 1, the robustness phase shifter of the i-th transmitter chain is positioned downstream (according to the propagation direction of the transmission signal) of the power amplifier, i.e., between the output of the power amplifier and the duplexer.

The compensation phase shifter of the i-th transmitter chain is placed upstream of the power amplifier, i.e., between the output of the controllable phase shifter and the input of the power amplifier.

The robustness phase shifter of the i-th transmitter chain brings in a predefined phase ϕᵢ; into the transmission signal. Such phase is found in the reflection coefficient of the feed line connecting the transmitter chain to the radiating element. The variation in the phase of the reflection coefficient is reflected by a variation in the impedance of the load connected to the output of the transmitter chain, i.e., of the power amplifier.

The compensation phase shifter of the i-th transmitter chain brings in a predefined phase ϕ′ᵢ into the transmission signal.

The sum of the phase ϕᵢ brought in by the robustness phase shifter of the i-th transmitter chain and the phase ϕ′ᵢ brought in by the compensation phase shifter of the i-th transmitter chain is a constant Cste, which is common to all the transmitter chains of the same elementary antenna 5.

Thereby:

$$∀ i , i ∈ \{ 1 , 2 , … , N \} : {ϕ}_{i} + {ϕ}_{i}^{′} = Cste$$

Such constant may differ from one elementary antenna to another.

The compensation phase shifter thus compensates for the phase shift brought in by the robustness phase shifter, and thereby guarantees that all the transmitter chains bring in the same total phase shift (ϕᵢ+ϕ′ᵢ) downstream of the controllable phase shifter.

The phase ϕᵢ brought in by a robustness phase shifter is specific to the i-th transmitter chain. In other words, two robustness phase shifters of the elementary antenna bring in different phases: ∀i, ∀j, i≠j: ϕᵢ≠ϕⱼ

Preferably, the phases brought in by the N robustness phase shifters are uniformly distributed in the interval [0°; 180° [, the phases brought in being modulo 180°/N.

With N equal to 4, the phases are then distributed modulo 45°.

The phases 0°, 45°, 90° and 135° are e.g. chosen as phases brought in by the first, second, third and fourth robustness phase shifters 213, 223, 233 and 243, respectively.

And the phases 135°, 90°, 45°, and 0° are chosen as the phases brought in by the first, second, third, and fourth compensation phase shifters 211, 221, 231, and 241, respectively, in order to ensure that the total phase brought in by each pair of phase shifters is constant from one transmitter chain to another (downstream of the controllable phase shifters): Cste=135°.

In FIG. 1, the radiating element 10 is, therefore, excited by four feed lines carrying emission signals equiphase-shifted by the phase shifter means presented hereinabove.

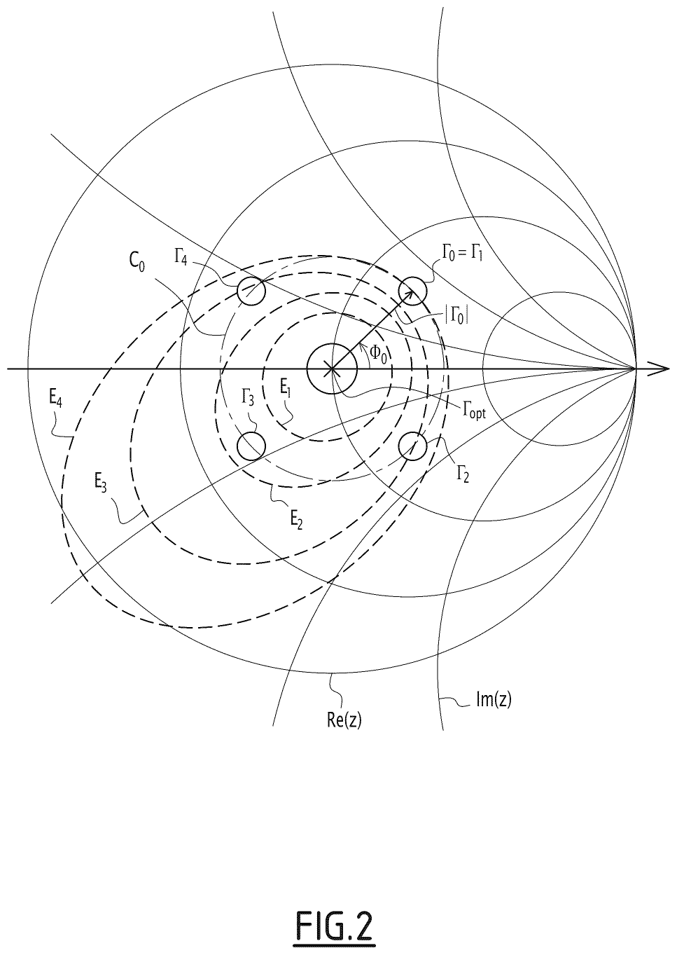

FIG. 2 illustrates the effect of implementing robustness phase shifters according to the invention.

FIG. 2 is a Smith chart, known to a person skilled in the art.

The Smith chart serves to represent reflection coefficients of a load connected by a transmission line to the output of a component, in the present case the reflection coefficient of Γ the radiating element connected to the output of the power amplifier of a transmitter chain by a transmission line.

The impedance of the load is denoted by Z.

There is a bijection between the reflection coefficient Γ and the impedance Z of the load:

$$\begin{matrix}Γ = \frac{Z - 1}{Z + 1} \\ Z = \frac{1 + Γ}{1 - Γ}\end{matrix}$$

From the point on the Smith chart representing a reflection coefficient Γ, a first network of circles (Re(z)) makes it possible to read the real part of a normalized impedance, and a second network of circles (Im(z)) makes it possible to read the imaginary part of the normalized impedance. The Smith chart represents the normalized impedance, defined as:

$$Z = \frac{Z}{Z c} ,$$

where Zc is a characteristic impedance of the transmission line. The real and imaginary parts of z make it possible to go back to the value of the impedance Z, knowing the length of the transmission line and hence Zc.

For a given amplifier, a so-called load pull electronic device is connected to the output of the amplifier and successively presents different values of the reflection coefficient. For each value, characteristic variables of the amplifier are measured, such as maximum power or the efficiency. As a result, it is possible to plot iso-performance curves on the Smith chart, e.g., for the maximum power or for the efficiency.

At the end of such tests, an optimal reflection coefficient Γₒₚₜ is chosen depending on the application. For example, a value is chosen making possible a certain compromise between maximum power and efficiency for a power amplifier.

The optimal reflection coefficient Γₒₚₜ may be fictititiously returned to the center of the Smith chart (Γₒₚₜ=0). Indeed, a power amplifier generally consists of an actual amplification stage (set of transistors) and a matching stage (winding and capacitance). It is the matching stage that actually makes it possible to present the optimal reflection coefficient to the amplification stage.

Thereby, returning to the presentation of the invention, the optimal reflection coefficient Γₒₚₜ, corresponding to the optimal impedance Zₒₚₜ, is chosen to optimize the features of the power amplifier.

The optimal matching coefficient Γₒₚₜ is obtained at the center of the Smith chart.

However, due to impedance mismatch, the impedance Z₀ actually connected to the output of the power amplifier is different from Zₒₚₜ. Same corresponds to the reflection coefficient Γ₀ on the Smith chart.

As a complex number, the reflection coefficient is written: Γ₀=|Γ₀|exp(jϕ₀), with |Γ₀| the amplitude and do the phase.

On the Smith chart shown in FIG. 2, a plurality of iso-performance curves of efficiency of the power amplifier considered have been represented.

For example, the first curve E₁, the innermost, corresponds to a decrease of one decibel compared to the optimum efficiency obtained for Γₒₚₜ, the second curve E₂ corresponds to a decrease of two decibels compared to the optimum efficiency, the third curve E₃ corresponds to a decrease of three decibels compared to the optimum efficiency and the fourth curve E₄, the outermost, corresponds to a decrease of four decibels compared to the optimum efficiency.

The curves are not circular around Γₒₚₜ (i.e., the maximum efficiency obtained for the optimal impedance Zₒₚₜ), but have an elliptical shape.

Since one of the possible causes of the impedance mismatch is due to a coupling between the radiating element of the elementary antenna in question and the neighboring radiating elements, the impedance mismatch is a feature of the radiating element.

The impedance mismatch is thus the same for the different power amplifiers addressing the different ports of the same radiating element.

Hence, without the implementation of the invention, the reflection coefficients seen by the different amplifiers of the TRM 20 are equal and are located at the same point, in the present case Γ₀.

The reflection coefficient Γ₀ is somewhere on a circle C₀ of center Γₒₚₜ and of radius |Γ₀|. The position thereof is not controlled and may correspond in particular to a significant degradation of the performance of the power amplifiers of the same elementary antenna. Thereof is represented in FIG. 2, where the reflection coefficient Γ₀ is on curve E₄, i.e. a decrease of four decibels compared to the optimum efficiency according to the example given.

Since the reflection coefficient Γ₀ is not a priori identical from one elementary antenna to another (which is all the more so for elementary antennas at the periphery of the array), thereof leads to a high variability in the performance of the constituent elementary antennas of an array antenna.

On the other hand, by implementing the invention, namely by bringing in a characteristic phase ϕᵢ downstream of each power amplifier, the impedance mismatch becomes specific to each transmitter chain of the same elementary antenna.

The reflection coefficient of the i-th emission chain then becomes:

$${Γ}_{i} = \vert {Γ}_{0} \vert exp ( j ( {ϕ}_{0} - 2 {ϕ}_{i} ) ) .$$

Due to the robustness phase shifter, a rotation about the optimum load point Γₒₚₜ is performed. The reflection coefficient of Γᵢ is thereby shifted from the i-th emission chain on the circle C₀.

Since the phases ϕᵢ are different from one transmitter chain to another, the reflection coefficients Γᵢ are no longer superimposed at the same point, but are distributed over the circle C₀. Advantageously, same are distributed uniformly over the circle C₀.

With the previous choice of phases, the first reflection coefficient Γ₁ is not shifted, the second reflection coefficient Γ₂ is shifted by −90°, the third reflection coefficient Γ₃ is shifted by −180°, and the fourth reflection coefficient Γ₄ is shifted by −270° (or +90°).

Hence, the different reflection coefficients are now on different iso-performance curves. Some reflection coefficients will be found on iso-efficiency curves better than the original curve or better than the original curve (E₄ in the example given).

Thereby, with the implementation of the invention, the power amplifiers do not undergo the same degradation in performance, which means that the overall variation in performance of the elementary antenna varies less than in the prior art where all the amplifiers connected to the same radiating element can simultaneously undergo a significant degradation. The TRM of an elementary antenna is thus made more robust against an impedance mismatch.

Hence, the variability between the elementary antennas of an array antenna is reduced.

The major advantage of the invention is thus to provide robustness against load variations ate the level of each radiating element, and thus to make the array antenna as a whole more efficient. In addition, polarization agility is maintained.

The role of the compensation phase shifter is to bring in a phase to compensate the phase brought in by the robustness phase shifter so that the radiating element is finally correctly excited, i.e., by in-phase signals.

In practice, the robustness phase shifter can be placed either in the MMIC (Monolithic microwave integrated Circuit) chip carrying the power amplification function, or in the reception printed circuit of the MMIC chip, at the interconnection between the MMIC chip and the port of the radiating element. In a variant, the robustness phase shifter is made in a hybrid manner by placing one part in the MMIC chip and the other part in the printed circuit.

The robustness phase shifter is preferably implemented by a delay line bringing in a constant phase shift for a given frequency band.

As for the compensation phase shifter, the function thereof can be fulfilled by the controllable phase shifter already present to ensure the functions of electronic scanning and of polarization agility. Same must then be controlled appropriately in order to bring in the required compensation phase. The value of the compensation phase is added to the phase control of a controllable phase shifter. Phase compensation upstream of the power amplifiers can thereby be implemented in the depointing control laws without having to implement an additional phase shifter. There is thus only one phase shifter.

Although the invention has been presented above in order to remedy the impedance mismatch at the output of the different transmitter chains of a TRM, the invention can also be applied, if appropriate in an independent manner, to the impedance mismatch at the input of the different receiver chains of a TRM.

Thereby, as shown in FIG. 1, the i-th receiver chain incorporates a robustness phase shifter, which is positioned upstream (in the direction of propagation of the reception signal) of the low-noise amplifier, i.e., between the input of the low-noise amplifier and the duplexer. The compensation phase shifter is placed downstream of the low-noise amplifier, i.e., between the output of the low-noise amplifier and the input of the controllable phase shifter.

Thereby, the first receiver chain 31 successively includes a robustness phase shifter 313, an amplifier 312, a compensation phase shifter 311, and a controllable phase shifter 310; the second transmitter chain 32 successively includes a robustness phase shifter 323, an amplifier 322, a compensation phase shifter 321, and a controllable phase shifter 320; the third transmitter chain 33 successively includes a robustness phase shifter 333, an amplifier 332, a compensation phase shifter 331, and a controllable phase shifter 330; and the fourth transmitter chain 34 includes successively a robustness phase shifter 343, an amplifier 342, a compensation phase shifter 341, and a controllable phase shifter 340.

The robustness phase shifter of the i-th receiver chain brings in a constant phase ϕᵢ into the signal received from the i-th port of the radiating element 10.

The compensation phase shifter of the i-th receiver chain brings in a constant phase ϕ′ᵢ into the received signal.

The sum of the phase ϕᵢ brought in by the robustness phase shifter of the i-th receiver chain and the phase ϕ′ᵢ brought in by the compensation phase shifter of the i-th receiver chain is a constant Cste, which is common to all the receiver chains of the elementary antenna 5.

Thereby:

$$∀ i , i ∈ \{ 1 , 2 , … N \} , {ϕ}_{i} + {ϕ}_{i}^{′} = Cste$$

All this so that the different signals received at the output of the receiver chains of the same radiating element are equiphase-shifted by the phase shifter means presented hereinabove.

The phase ϕᵢ brought in by a robustness phase shifter is specific to the i-th receiver chain. In other words, two robustness phase shifters of the elementary antenna bring in different phases.

The load presented at the input of the different low-noise amplifiers of the elementary antenna is thereby modulated with the effect of reducing the variability of the signal-to-noise ratio and/or of the linearity of the different elementary antennas of the array antenna operating as a receiver.

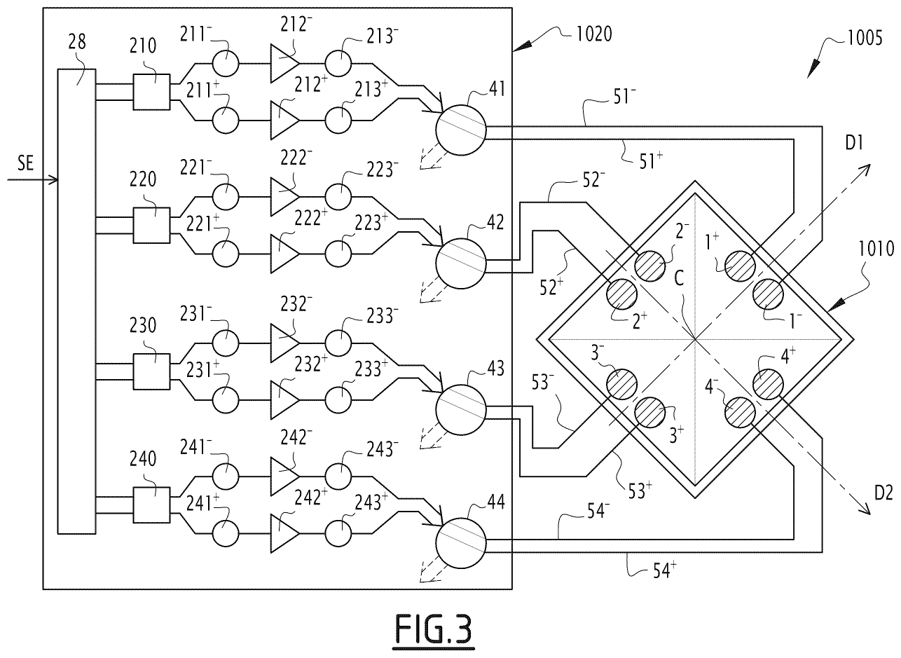

FIG. 3 illustrates a second embodiment. The elementary antenna 1005 includes a TRM 1020 and a radiating element 1010.

For clarity, FIG. 3 has been limited to the means of transmission, but a similar description could be given for the means of reception.

The radiating element 1010 includes four pairs of ports. Each pair of ports has a positive port and a negative port.

The ports of the same pair of ports are differentially fed by a suitable transmitter chain.

Thereby, a component of the second embodiment identical to a component of the first embodiment is referenced by the same reference number as same used in FIG. 1 to reference the corresponding component. The references of the components of the second embodiment carry an index + or − depending on the positive or negative port of the pair of ports same address.

Thereby, for the i-th positive transmitter chain which is associated with the positive port i⁺ of the i-th pair of ports, a positive robustness phase shifter is positioned downstream of the positive power amplifier, i.e., between the output of the positive power amplifier and the duplexer, to bring in a positive phase ϕᵢ⁺. A positive compensation phase shifter is placed upstream of the positive power amplifier, i.e., between the output of the controllable phase shifter and the input of the power amplifier, to bring in a positive phase ϕ′ᵢ⁺.

Thereby, for the i-th negative transmitter chain, which is associated with the negative port i⁻ of the i-th pair of ports, a negative robustness phase shifter is positioned downstream of the negative power amplifier, i.e., between the output of the negative power amplifier and the duplexer, to bring in a negative phase ϕᵢ⁻. A negative compensation phase shifter is placed upstream of the negative power amplifier, i.e., between the output of the controllable phase shifter and the input of the power amplifier, to bring in a negative phase ϕ′ᵢ⁻.

We keep the constraint:

$$∀ i , i ∈ \{ 1 , 2 , … N \} , {ϕ}_{i}^{+} + {ϕ}_{i}^{′ +} = {ϕ}_{i}^{-} + {ϕ}_{i}^{′ -} = Cste$$

For example, for the embodiment in FIG. 3, with four pairs of ports, the following set of phases is retained:

$$\begin{matrix}{ϕ}_{1}^{+} = {ϕ}_{1}^{-} = 0 ° ; {ϕ}_{1}^{′ +} = {ϕ}_{1}^{′ -} = 135 ° \\ {ϕ}_{2}^{+} = {ϕ}_{2}^{-} = 45 ° ; {ϕ}_{2}^{′ +} = {ϕ}_{2}^{′ -} = 90 ° \\ {ϕ}_{3}^{+} = {ϕ}_{3}^{-} = 90 ° ; {ϕ}_{3}^{′ +} = {ϕ}_{3}^{′ -} = 45 ° \\ {ϕ}_{4}^{+} = {ϕ}_{4}^{-} = 135 ° ; {ϕ}_{4}^{′ +} = {ϕ}_{4}^{′ -} = 0 °\end{matrix}$$

In a variant, it is possible to ensure that the two amplifiers of the same transmitter chain are not associated with the same reflection coefficient, by choosing ϕᵢ⁺ different from ϕᵢ⁻. Thereof corresponds in fact to considering the radiating element as fed by eight ports and not by four pairs of ports.

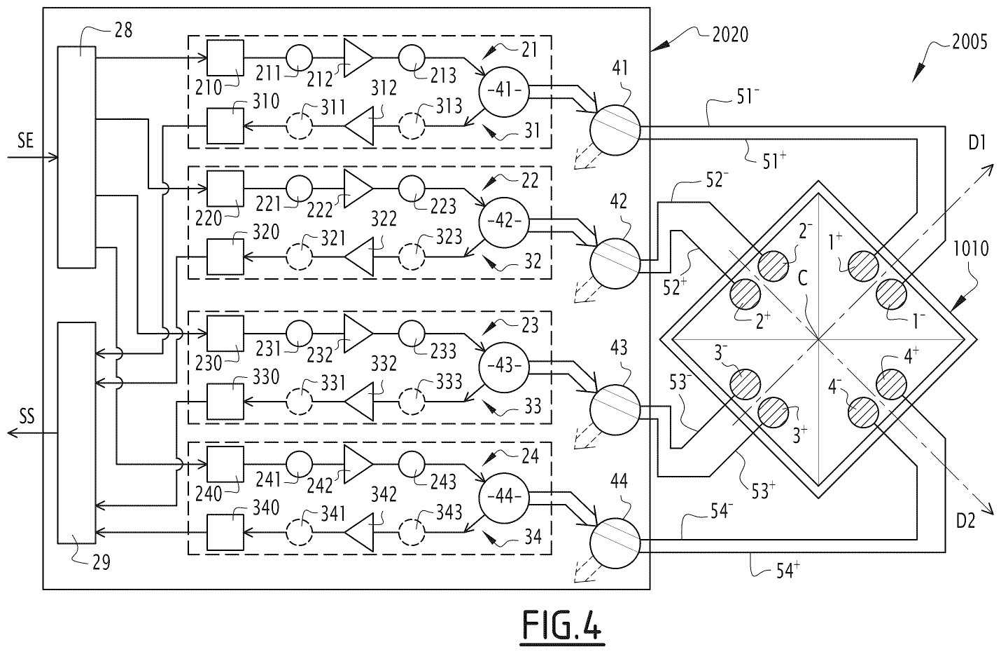

FIG. 4 shows a third embodiment. The elementary antenna 2005 includes a TRM 2020 and a radiating element 1010 which, like the radiating element of the second embodiment, is fed in differentially.

A component of the third embodiment identical to a component of the first embodiment is referenced by the same reference number as same used in FIG. 1 to reference the corresponding component.

In the third embodiment, the i-th transmitter chain, which is associated with the positive port i⁺ and the negative port i⁻ of the i-th pair of ports, includes a single power amplifier (2212 for the first chain 2021), having one input and two differential outputs.

A robustness phase shifter (2213 for the first chain 2021), which is positioned between the output of the power amplifier and the duplexer, has two differential inputs and two differential outputs. The robustness phase shifter brings in a phase of identical robustness ¢; on the two differential connections.

A compensation phase shifter (211 for the first chain 2021) is placed upstream of the power amplifier, i.e., between the output of the controllable phase shifter (210 for the first chain 2021) and the input of the power amplifier, in order to bring in a compensation phase ϕ′ᵢ.

The following requirement is kept once again:

$$∀ i , i ∈ \{ 1 , 2 , … N \} , {ϕ}_{i} + {ϕ}_{i}^{′} = Cste$$

A set of robustness phases is selected such that:

$$∀ i et ∀ j , i et j ∈ \{ 1 , 2 , … N \} , i \neq j , {ϕ}_{i} \neq {ϕ}_{j} .$$

The invention can be implemented in an antenna comprising only a single elementary antenna, i.e., a single radiating element.

By implementing the invention in each of the constituent elementary antennas of an array antenna, the behavior of the different radiating devices is homogenized.

Since compensation is performed locally on each radiating element of the array antenna, it fits the position of the radiating element in question within the antenna.

In an elementary antenna operating in transmit and receive mode, the invention can be implemented in transmit mode only, in receive mode only, or simultaneously in transmit mode (to remedy the impedance mismatch between the radiating element and the different transmitter chains) and in receive mode (to remedy the impedance mismatch between the radiating element and the different receiver chains).

In the latter case, the phases brought in by the transmitter chain and by the receiver chain of the same chain may be identical or different.

If same are identical, the robustness phase shifter is advantageously placed between the duplexer and the radiating element, along the feed line of the corresponding port of the radiating element. A single robustness phase shifter is then placed in common for the transmission and the reception. For example, the phase shifters 213 and 313 are replaced by a common robustness phase shifter implemented on the line 51.

A hybrid solution is possible, wherein one part of the robustness phase shifter is on one side of the duplexer and the other part of the robustness phase shifter is on the other side of the duplexer, on the feed line of the port.

In another variant, the invention is implemented in transmission mode in an antenna operating only in transmission mode (comprising only transmitter chains and hence not comprising receiver chains) or in reception mode in an antenna operating only in reception mode (comprising only receiver chains and hence not comprising transmitter chains).

Alternatively, in an array antenna, even if its technical teaching gives poorer results than the invention due to the different positions of the unitary elements, the teaching of WO 2023/072749 could be implemented between elementary antennas to neutralize impedance variations between elementary antennas, while implementing the invention between ports of an elementary antenna to neutralize impedance variations within each elementary antenna.

The present invention has applications mainly in the field of radars. It may nevertheless have applications in jammers, radios and data links, as well as of multifunction systems using active electronically scanned array antennas.

1. An elementary antenna comprising:
a radiating element comprising N excitation zones, N being an integer greater than or equal to two, an excitation zone being a port or a pair of ports;
a transmit and/or receive module comprising, for each integer i between 1 and N, an i-th chain connected, via an i-th transmission line, to the i-th excitation zone of said radiating element, the i-th chain comprising an i-th amplifier; and
for each chain,
an i-th robustness phase shifter, located on a first side of said i-th amplifier, between said i-th amplifier and said radiating element; and
an i-th compensation phase shifter, located on a second side of said i-th amplifier opposite the first side, and wherein the sum of the phases brought in by said i-th robustness phase shifter and the i-th compensation phase shifter is constant whichever chain is considered, and the phase brought in said i-th robustness phase shifter is strictly different from the phase brought in by the other robustness phase shifters of the other chains of the elementary antenna.

2. The elementary antenna according to claim 1, wherein each chain is a transmitter chain, the amplifier of the i-th chain comprising a power amplifier.

3. The elementary antenna according to claim 1, wherein each chain is a receiver chain, the amplifier of the i-th chain being a low-noise amplifier.

4. The elementary antenna according to claim 1, wherein the phases brought in by said robustness phase shifters are uniformly distributed over the interval [0°; 180°].

5. The elementary antenna according to claim 4, wherein said radiating element comprises four ports, and wherein the phases brought in by the first, second, third and fourth robustness phase shifters are equal to 0°, 45°, 90° and 135°, respectively.

6. The elementary antenna according to claim 5, wherein the phases brought in by the first, second, third and fourth compensation phase shifters are equal to 135°, 90°, 45° and 0°, respectively.

7. The elementary antenna according to claim 1, wherein said radiating element comprises N pairs of ports, and wherein the i-th chain comprises an i-th positive amplifier and an i-th positive robustness phase shifter associated with a positive port of the i-th pair of ports, and an i-th negative amplifier and an i-th negative robustness phase shifter associated with a negative port of the i-th pair of ports.

8. The elementary antenna according to claim 1, wherein the i-th robustness phase shifter comprises an i-th delay line.

9. The elementary antenna according claim 1, wherein the i-th compensation phase shifter is integrated into an i-th controllable phase shifter of the i-th chain.

10. An active electronically scanned array antenna comprising an array of elementary antennas, wherein each elementary antenna in the array is consistent with the preceding elementary antenna in the array according to claim 1.
